(19) United States
(12) Patent Application Publication
(10) Pub. No.: US 2002/0174065 A1
(43) Pub. Date: Nov. 21, 2002

(54) Multi-currency electronic payment system and terminal emulator

(76) Inventor: Chalice Coward, Parker, CO (US)

Correspondence Address: William J. Kubida, Esq., Hogan & Hartson, LLP, Suite 1500, 1200 17th Street, Denver, CO, 80202, US

(21) Appl. No.: 09/860,676

(22) Filed: May 18, 2001

(51) Int. Cl. G06F 17/60

(52) U.S. Cl. 705/39; 705/35

(57) ABSTRACT

A terminal emulator implemented as client software executing on a merchant's computer system. In a particular example, the terminal emulator is implemented within a web browser. The terminal emulator is identified by a terminal ID, and is dynamically configured to operate using the transaction logic and currency desired for a current transaction. A single terminal emulator is dynamically configured to support multiple currencies and/or transaction logic variations. At transaction time, a specific currency and transaction logic for the transaction are selected.

### BACKGROUND OF THE INVENTION

1. Field of the Invention

The present invention relates, in general, to a system and method for conducting transactions electronically, and, more particularly, to software, systems and methods for conducting payment transactions in between entities using multiple, different currencies.

2. Relevant Background

The rapidly evolving electronic commerce environment increasingly involves multi-national transactions. This is driven by greater product/service variety and efficiencies that can be realized with global markets as compared to national or local markets. The rapid advances in computing and networking technology enables many of these transactions to be processed in a highly automated fashion.

Merchants use credit card terminals to “capture” credit card information (i.e., enter card-specific data) and transaction-specific data for processing. The credit card terminal implements the transaction logic required to obtain the credit card numbers, determine whether the transaction type (e.g., card present, card not present), input the transaction amount, and the like. The merchant sends the data to a merchant services provider that provides credit card processing services.

A number of businesses provide merchant services to handle the payment processing for merchants who accept credit, charge and debit cards as payments for goods and services. The merchant's credit card terminal connects the merchant to the merchant services provider. The merchant uses the terminal to input transaction parameters (e.g., account number, transaction amounts, and the like) and receive authorization information. The transaction logic implemented by the terminal varies somewhat from terminal-to-terminal to account for different currencies, bank logic, file formats required by merchant services providers and/or depository logic involved in the payment transaction.

Merchant services enable the merchant to accept a variety of debit card and credit card types (e.g., Visa, MasterCard, American Express, Discover, etc.), provide real-time charge authorizations, and settlement services to transfer funds to the merchant's accounts. Merchant services providers may also provide other services such fraud management and dispute handling procedures, as well as a variety of reconciliation and reporting services.

One continual problem in multi-national commerce transactions, however, is created by the need to conduct transactions in a particular currency of a particular jurisdiction. Conventional credit card terminals only understand one currency and one set of transaction logic. However, monetary systems and currencies differ from country-to-country. Even with the advent of regional currencies such as the Euro, each credit card terminal is localized to their native country's currency and is not adaptive to use other currencies and/or transaction logic.

When a merchant desires to do business in a particular country, it is advantageous, if not necessary, to be able to conduct transactions in the local currency of that country (e.g., the currency native to the buyer). Although the Internet is global, it is difficult for a U.S. customer, for example, to conduct a transaction when the merchant is only configured to accept Italian Lira. The merchant can manually perform the currency conversion, to create an appearance that the transaction is performed in the customer's native currency. However, the transaction is actually entered into a conventional credit card terminal using the currency dictated by the credit card terminal. The customer then receives a statement which reflects a currency conversion performed by the credit card processor at an exchange rate that may be different from the exchange rate that existed at the time of the transaction. Even subtle variations in exchange rate make it difficult to reconcile transaction records.

To enable transactions in many local currencies, a merchant may establish relationships with merchant services providers in each jurisdiction and currency in which it does business. The merchant will then have separate credit card terminals localized to each jurisdiction's currency. For example, a first merchant services provider handles transactions in Lira while a separate merchant services provider handles transactions in U.S. Dollars. Such an arrangement makes some sense when the merchant is has physical locations or storefronts in each jurisdiction, however, makes little sense in the electronic commerce environment.

This solution is not only clumsy, but costly as the per-transaction costs associated with multiple small accounts is greater than for a single large account. Moreover, the merchant services relationships typically have a recurring fee associated with them. Also, it takes a quantity of time and administrative resources to set up and manage each merchant services relationship. From the merchant's perspective, sales are transacted by multiple, independent systems that do not readily allow for consolidation of reports.

Because each merchant services provider may supply a varying level and/or quality of service, it is difficult for the merchant to ensure that customers receive a consistent experience as the merchant expands into new markets. Common functions such as settlement and fraud management are inefficiently duplicated in each of the merchant services providers. The high level reports provided to merchants often hide transaction details. Moreover, the merchant must consolidate the various, typically disparate reports from the multiple merchant services providers in order to reconcile its own accounts and track sales performance internally.

Recently, some merchant services providers create affiliations with various other merchant services providers. In theory, a merchant can deal directly with any member of the affiliation, and transact business in the currency of any/all of the affiliation members. While this model provides some improvements in that a merchant need not have direct relationships with each affiliate, the various service providers continue to operate with disparate sets of services and reporting mechanisms. For example, merchants must still purchase a merchant ID from each affiliate to enable transactions to be tracked to that merchant. In the end, these affiliate systems hide, but do not eliminate, some of the extraordinary costs associated with conducting financial transactions in multiple currencies.

### SUMMARY OF THE INVENTION

Briefly stated, the present invention involves a terminal emulator implemented as client software executing on a merchant's computer system. In a particular example, the terminal emulator is implemented within a web browser. The terminal emulator is identified by a terminal ID, and is dynamically configured to operate using the transaction logic and currency desired for a current transaction. A single terminal emulator is dynamically configured to support multiple currencies and/or transaction logic variations. At transaction time, a specific currency and transaction logic for the transaction are selected.

In another aspect, the present invention involves a method for conducting transactions comprising the acts of implementing a credit card terminal emulator having an assigned terminal ID as one or more software processes running on a client machine. A merchant selects a set of transaction parameters that define within the terminal emulator transaction logic and currency to be used for a particular transaction. The terminal emulator captures credit card information and transaction information and transmits the information with the terminal ID to merchant engine processes that provide a selected set of merchant services including communication with a credit card processor.

### BRIEF DESCRIPTION OF THE DRAWINGS

FIG. 1 shows entities and relationships involved in an prior art commerce environment;

FIG. 2 shows an electronic commerce environment in which the present invention is implemented; and

FIG. 3 illustrates processes involved in transactions in accordance with the present invention.

### DETAILED DESCRIPTION OF THE PREFERRED EMBODIMENTS

The present invention is directed to systems, methods and software that enable a merchant to emulate a credit card terminal that performs transactions in multiple currencies. These transaction processes include credit card capture, pre-authorization, post authorization, sales, and reporting. Preferably, the terminal emulator interacts with a single merchant services provider so that a merchant can avoid multiple independent relationships with many merchant services providers and local banks in each jurisdiction in which they do business.

The present invention is illustrated and described in terms of a distributed computing environment such as an enterprise computing system using public communication channels such as the Internet. However, an important feature of the present invention is that it is readily scaled upwardly and downwardly to meet the needs of a particular application. Accordingly, unless specified to the contrary the present invention is applicable to significantly larger, more complex network environments as well as small network environments such as conventional LAN systems.

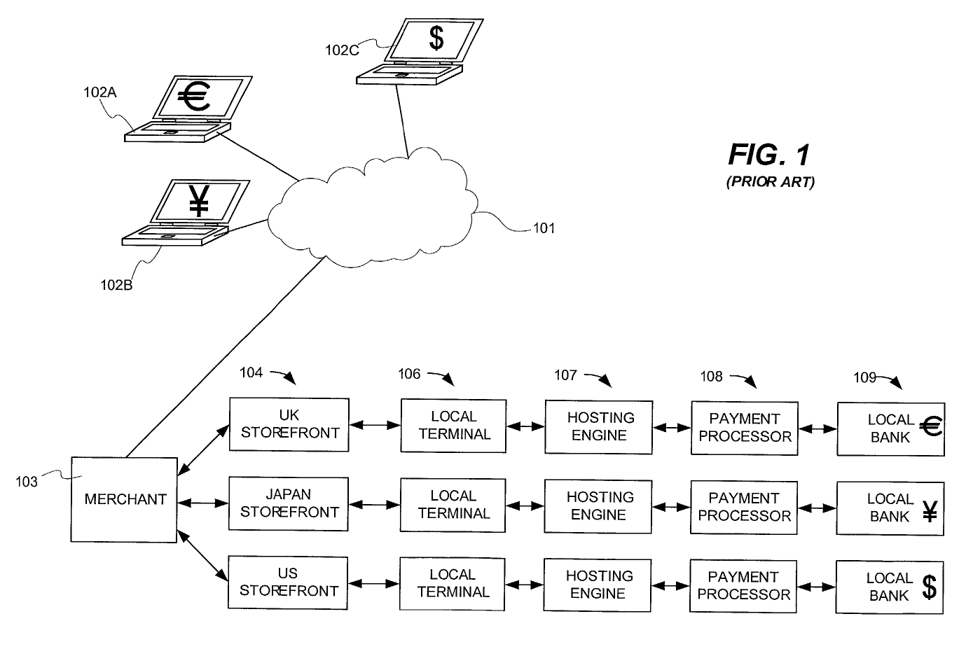

FIG. 1 shows prior art computing environment 100 used to implement credit transactions over a network 101 such as the Internet. Purchasers using client machines 102a-102c, for example, use a variety of devices to conduct information exchanges and transactions of various types with merchants 103. In the particular examples, merchant 103 presents a web-based interface in the form of static and/or dynamic web pages that can be accessed by HTTP or secure HTTP requests from client machines 102a-102c. It is contemplated that non-web-based protocols may be substituted with appropriate changes to the client and server software.

As shown in FIG. 1, users conduct transactions in a variety of currencies such as Eurodollars (client 102a), Yen (client 102b) and U.S. dollars (client 102C). Users may be geographically distributed and operating in the local currency where the client machine 102a-102c is located. Alternatively, users may be using a non-local currency such that a user geographically located in the United States may desire to use an alternate currency such as Eurodollars. While local law may regulate such transactions, the present invention does not. As discussed below, these currency choices are made independent of the geographic location or preferred currency of merchant 103.

An HTTP request is directed to the web site of merchant 103. Merchant web site 103 may be implemented as a single interface that that routes transactions to a particular storefront 104. Alternatively, each storefront 104 implements a web interface such that once redirected to a desired storefront 104, all client/merchant exchanges occur through the storefront 104 rather than merchant interface 103. Each storefront 104 provides, for example, locale-specific customizations that may effect the language, currency, product/service availability, or other customizations that are unique to a particular geography or customer base.

At the point of payment or payment authorization in the transaction, merchant 103 captures credit card information through a variety of available mechanisms. Captured information includes, for example, card number, expiration date, card owner name, transaction amount and other desired transaction-specific information. This information may be captured by an HTML form through the web site with or without secure HTTP data transport, out of band over a telephone link, by accessing stored credit card information held by merchant 103 or a third party resource, or the like.

Merchant 103 formats the captured information into a format required by a credit card terminal 107. Conventionally, each terminal 107 is localized to the native locale of the transaction, and must be replicated for each locale supported by merchant 103. Terminal 107 may be a conventional card-swipe point of sale terminal with a human operator entering information, or may be an automated terminal. Significantly, however, terminals 107 are each configured for a particular local, and cannot support transactions from other locales.

Local terminals 107 contact a hosting engine 107 such as a ClearCommerce engine. The hosting engine 107 serves as an interface to one or more payment processors 108, which in turn serve as interfaces to local banks 109. These connections are typically conducted over special-purpose private communication channels rather than a public channels such as the Internet. Because of the locale-constrained nature of conventional data exchanges, hosting engine 107, payment processors 108 and local banks 109 are all locale-specific and must be replicated for each locale supported by merchant 103.

Hence, when merchant 103 desires to support a new locale, the entire chain of processes from storefront 104 through local bank 109 must be replicated. The cost and inefficiency of this replication is significant. Moreover, merchant 103 receives reports from various entities for accounting and management purposes. These reports come from disparate sources (e.g., multiple hosting engines 107, payment processors 108 and local banks 109), and are difficult to reconcile and aggregate.

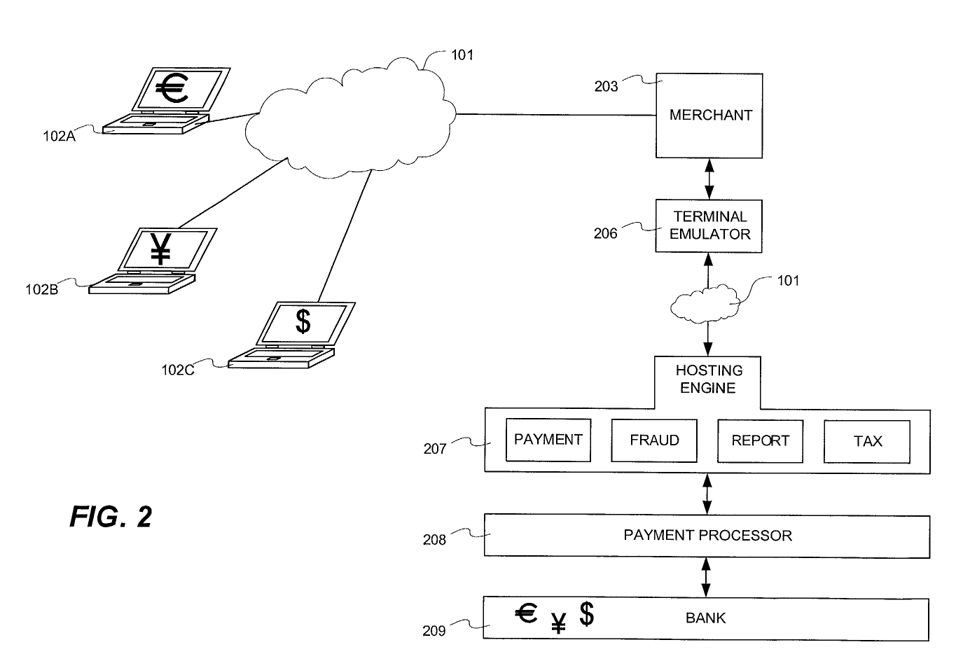

FIG. 2 illustrates a transaction environment using a terminal emulator in accordance with the present invention. Clients 102a-102c conduct data transactions with merchant 203 in a substantially conventional manner. Merchant 203 may implement a single, multi-locale interface or multiple single locale interfaces as described hereinbefore. Merchant 203 captures credit card information at the point of payment or payment authorization. The present invention recognizes that the processes used by multiple credit card terminals 106 used in the past are largely analogous if not identical. Accordingly, the single terminal emulator 206 consolidates this functionality by enabling dynamic configuration of these processes to support particular locals rather than replicating the processes in multiple terminals 106.

Merchant 203 implements a terminal emulator 206 that that is configurable to support multiple locales. Depending on the needs of a particular client 102a-102c, terminal emulator 206 is automatically configured to capture specific information used in each supported locale. Preferably, emulator 206 implements a web interface for conducting transactions with hosting engine 207 using a web interface. This feature enables the channel between emulator 206 and hosting engine 207 to be implemented over a public network such as the Internet, preferably using secure protocols.

Merchant services 207 implement a plurality of desired services on behalf of the merchant 203. One advantage of the present invention is that merchant 203 can rely on a cohesive set of services irrespective of the locale. In the past, merchants 203 were constrained in some locales by the merchant services available in that locale. Also, the various merchant services such as payment processing, fraud management, reporting, taxing, and the like readily communicate with each other. This allows a consistent experience for purchasers and merchants 203, as well as aggregated reporting across multiple locales.

Similarly, a single payment processor 208 and/or single bank 209 may be selected by a merchant 203. Payment processors 208 and banks 209 are available that provide services in multiple currencies, however, until now these services were difficult to leverage by merchants who where already required to use locale-specific merchant services. Although surprising, these limitations are essentially imposed by the need to use locale-specific credit card terminals 106. The multi-locale terminal emulator 206 in accordance with the present invention enable merchants to leverage systems, software and established relationships to obtain and provide superior services.

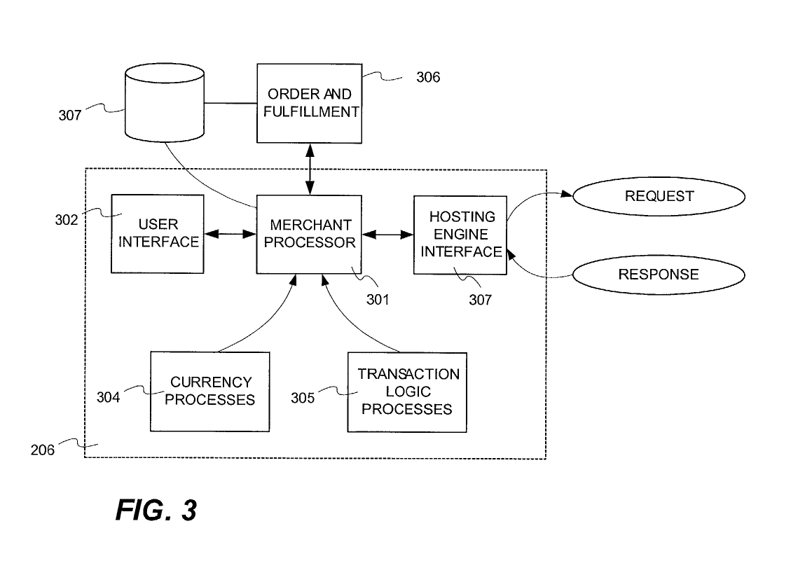

FIG. 3 illustrates processes and data exchange relationships implemented by an exemplary terminal emulator 206 in accordance with the present invention. At the heart of terminal emulator 206 is a set of merchant processor processes 301 that implement data transactions that capture credit card data through user interface 302 and communicate with host engine 207 through, for example, host engine interface 303. These data transactions include, for example, constraining input to transaction needs, accessing data records stored in database 307, and reformatting input into messages suitable for hosting engine 207. Also, merchant processor component 301 may generate notifications to external processes such as order and fulfillment processes 306.

User interface processes 302 are preferably implemented as a web-based interface such as an HTML generator that produces HTML input forms. Interface processes 302 also implement corresponding processes to capture HTML responses. In such an implementation, much or all of the credit card capture processes can be automated. Alternatively, user interface processes 302 may be implemented by a human-operated graphical user interface, card swipe input mechanism, or the like for manual operation.

The comparatively generic processes implemented by merchant processor component 301 are dynamically configured by reference to currency processes 304 and transaction logic processes 305. Currency processes 304 may access internal or external data sources to define exchange rates or other currency-specific information needed. This feature can enable dynamic pricing taking into account current currency values.

Transaction logic processes 305 comprise locale-specific transaction processes that can be accessed, as required, to alter and/or augment merchant processor processes 301. It is contemplated that the transaction logic may vary somewhat from locale-to-locale to accommodate local law, custom and customer/merchant expectations. For example, a pre-authorization transaction (described below), may be customary in the United States for particular transactions, but be unavailable in other jurisdictions. In such cases, the generic processes 305 may be configured to implement the locale-specific logic.

Terminal emulator 206 implements a variety of transactions. These transaction types include, pre-authorization, post authorization, forced post authorization, sale transactions, and reporting transactions. Other transaction types, including locale-specific transaction types, are readily implemented using transaction logic processes 305. Responses from hosting engine 206 may include, for example, authorization codes, denial codes, error codes, as well as associated data.

In many jurisdictions, a merchant 203 cannot post a sale transaction that will actually transfer funds until goods and services have been delivered. Hence, the pre-authorization transaction type enables the merchant to capture credit card information and submit a request to hosting engine 206 that will return information indicating that the credit card is valid and charges can be made to the card. The information is stored in database 307 for later use in a sale transaction when the goods/services are provided. The sale transaction may be initiated manually or automatically based on triggers from order and fulfillment logic 306.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of conducting credit card payment transactions comprising:
determining a transaction environment describing for a transaction;
configuring a terminal emulator to operate in the transaction environment;
obtaining transaction-specific data;
submitting the transaction-specific data to a hosting engine; and
receiving a response from the hosting engine.

2. The method of claim 1 wherein the payment transaction comprises a pre-authorization transaction.

3. The method of claim 1 wherein the payment transaction comprises a post-authorization transaction.

4. The method of claim 1 wherein the payment transaction comprises a sale transaction.

5. The method of claim 1 further comprising reconfiguring the terminal emulator to operate in a different transaction environment using the same hosting engine.

6. The method of claim 1 further comprising maintaining transaction logs across multiple transaction environments in a coherent database.

7. The method of claim 1 wherein the act of configuring can be performed dynamically at transaction time.

8. The method of claim 1 wherein the act of configuring comprises a selecting a currency type to be used for the transaction.

9. The method of claim 1 wherein the act of configuring comprises selecting a language to be used for the transaction.

10. The method of claim 1 wherein the act of configuring comprises selecting file formats to be used in communication with the hosting engine.

11. A credit card terminal emulator comprising:
a user interface;
a host engine interface;
merchant processes coupled to the user interface and host engine interface and configured to capture credit card information and conduct authorization transactions with the host engine interface using the captured credit card information;
a set of dynamic configuration processes coupled to the merchant processes and operable to dynamically configure the merchant processes with locale-specific data and behavior based on a locale selected by the merchant.

12. The emulator of claim 11 wherein the user interface comprises an HTTP interface.

13. The emulator of claim 11 wherein the host engine interface comprises an HTTP interface.

14. The emulator of claim 11 wherein the set of dynamic configuration process include processes for selecting amongst a plurality of currencies, wherein the selected currency is used to conduct the authorization transactions.

15. The emulator of claim 11 wherein the set of dynamic configuration process include processes implementing locale-specific transaction logic.

16. A computer program product comprising computer implemented code devices stored on a tangible media and configured to cause a programmable computer to conducting credit card payment transactions, the computer program product comprising:
first program code devices configured to cause the computer to determine a transaction environment describing for a transaction;
second program code devices configured to cause the computer to configure a terminal emulator to operate in the transaction environment;
third program code devices configured to cause the computer to obtain transaction-specific data;
fourth program code devices configured to cause the computer to submit the transaction-specific data to a hosting engine; and
fifth program code devices configured to cause the computer to receive a response from the hosting engine.
